(19) United States
(12) Patent Application Publication
(10) Pub. No.: US 2024/0001160 A1
(43) Pub. Date: Jan. 4, 2024

(54) METHOD AND SYSTEM OF LOCATING AN EMERGENCY AIR FILL STATION OF A FIREFIGHTER AIR REPLENISHMENT SYSTEM IMPLEMENTED IN A STRUCTURE FOR ACCESS OF BREATHABLE AIR IN LOW VISIBILITY

(71) Applicant: Anthony J. Turiello, Westlake, TX (US)

(72) Inventor: Anthony J. Turiello, Westlake, TX (US)

(21) Appl. No.: 18/134,046

(22) Filed: Apr. 13, 2023

Related U.S. Application Data
(60) Provisional application No. 63/356,996, filed on Jun. 29, 2022.
(60) Provisional application No. 63/357,145, filed on Jun. 30, 2022.
(60) Provisional application No. 63/357,743, filed on Jul. 1, 2022.
(60) Provisional application No. 63/357,754, filed on Jul. 1, 2022.

(51) Int. Cl. A62B 7/02

(52) U.S. Cl. CPC A62B 7/02

(57) ABSTRACT

Disclosed are methods and a system of locating an emergency air fill station of a safety system implemented within a structure in low visibility. The safety system includes a source of breathable air, a fixed piping system within the structure for supply of the breathable air from the source across the safety system, and an emergency air fill station coupled to the fixed piping system to provide access to the breathable air therethrough for personnel to fill an air bottle. A sensor in conjunction with a processor detects a visibility parameter in a vicinity of the emergency air fill station. The processor automatically controls a parameter of one or more output device(s) located proximate to and/or on the emergency air fill station in accordance with the detection to aid the personnel in locating the emergency air fill station.

### CLAIM OF PRIORITY

This application is a conversion application of, and claims priority to, U.S. Provisional Patent Application No. 63/356,996 titled CLOUD-BASED FIREFIGHTING AIR REPLENISHMENT MONITORING SYSTEM, SENSORS AND METHODS filed on Jun. 29, 2022, U.S. Provisional Patent Application No. 63/357,145 titled METHOD AND SYSTEM OF SENSOR-BASED SMART UNLOCKING OF A FIREFIGHTER AIR REPLENISHMENT SYSTEM filed on Jun. 30, 2022, U.S. Provisional Patent Application No. 63/357,743 titled CONTINUAL AIR QUALITY MONITORING THROUGH LOCALIZED ANALYSIS OF BREATHABLE AIR THROUGH A SENSOR ARRAY filed on Jul. 1, 2022, and U.S. Provisional Patent Application No. 63/357,754 titled ON-DEMAND CERTIFICATION THROUGH COMMUNICATION OF ASSOCIATED AIR-QUALITY MARKER DATA TO A REMOTE CERTIFICATION LABORATORY filed on Jul. 1, 2022. The contents of each of the aforementioned applications are incorporated herein by reference in entirety thereof.

### FIELD OF TECHNOLOGY

This disclosure relates generally to emergency systems and, more particularly, to methods and/or a system of locating an emergency air fill station of a safety system implemented within a structure for access of breathable air in low visibility.

### BACKGROUND

A structure (e.g., a vertical building, a horizontal building, a tunnel, marine craft) may have a Firefighter Air Replenishment System (FARS) implemented therein. The FARS may have an emergency air fill station therein to enable firefighters and/or emergency personnel access breathable air therethrough. During a low visibility condition (e.g., during an emergency effecting power cuts), said firefighters and/or emergency personnel may not be able to locate the emergency air fill station, thereby slowing down a rescue operation requiring access to the breathable air as a precondition therefor. Further, the firefighters and/or emergency personnel may not be able to see obstacles (e.g., victims of emergencies, construction equipment) on the way to the emergency air fill station clearly, thereby further compromising the rescue operation.

### SUMMARY

Disclosed are methods and/or system of locating an emergency air fill station of a safety system implemented within a structure for access of breathable air in low visibility.

In one aspect, a method of a safety system of a structure having a fixed piping system implemented therein to supply breathable air from a source across the safety system to an emergency air fill station thereof for use by personnel to fill an air bottle is disclosed. The method includes detecting, through a sensor in conjunction with a processor, a visibility parameter in a vicinity of the emergency air fill station. The method also includes automatically controlling, through the processor, a parameter of one or more output device(s) located proximate to and/or on the emergency air fill station in accordance with the detection of the visibility parameter to aid the personnel in locating the emergency air fill station.

In another aspect, a method of a safety system of a structure having a fixed piping system implemented therein to supply breathable air from a source across the safety system to an emergency air fill station thereof for use by personnel to fill an air bottle is disclosed. The method includes detecting, through a sensor in conjunction with a processor, that a visibility parameter in a vicinity of the emergency air fill station is below a first threshold. The method also includes automatically controlling, through the processor, a parameter of one or more output device(s) located proximate to and/or on the emergency air fill station in accordance with the detection that the visibility parameter is below the first threshold to aid the personnel in locating the emergency air fill station.

In yet another aspect, a safety system of a structure includes a source of breathable air, a fixed piping system within the structure for supply of the breathable air from the source across the safety system, and an emergency air fill station coupled to the fixed piping system to provide access to the breathable air therethrough for personnel to fill an air bottle. The safety system also includes a sensor, and a processor communicatively coupled to a memory. The sensor in conjunction with the processor detects a visibility parameter in a vicinity of the emergency air fill station. The processor automatically controls a parameter of one or more output device(s) located proximate to and/or on the emergency air fill station in accordance with the detection of the visibility parameter to aid the personnel in locating the emergency air fill station.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a safety system associated with a structure, according to one or more embodiments.

FIG. 2 is a schematic and an illustrative view of an emergency air fill panel as an example emergency air fill station of the safety system of FIG. 1.

FIG. 3 is a schematic and an illustrative view of a rupture containment air fill station as another example emergency air fill station of the safety system of FIG. 1.

FIG. 4 is a schematic view of an air monitoring system and/or an emergency air fill station of the safety system of FIG. 1 including sensors to detect visibility of an environment thereof and/or air parameters of breathable air through the safety system, according to one or more embodiments.

FIG. 5 is a schematic and an illustrative view of the emergency air fill panel of FIG. 2 with one or more output light device(s) thereon.

FIG. 6 is a schematic view of the air monitoring system and/or the emergency air fill station of FIG. 3 with Thermal Imaging Cameras (TICs) associated therewith, according to one or more embodiments.

FIG. 7 is a process flow diagram detailing the operations involved in locating an emergency air fill station of a safety system implemented within a structure for access of breathable air in low visibility, according to one or more embodiments.

Other features of the present embodiments will be apparent from the accompanying drawings and from the detailed description that follows.

### DETAILED DESCRIPTION

Example embodiments, as described below, may be used to provide methods and/or a system of locating an emergency air fill station of a safety system implemented within a structure for access of breathable air in low visibility. Although the present embodiments have been described with reference to specific example embodiments, it will be evident that various modifications and changes may be made to these embodiments without departing from the broader spirit and scope of the various embodiments.

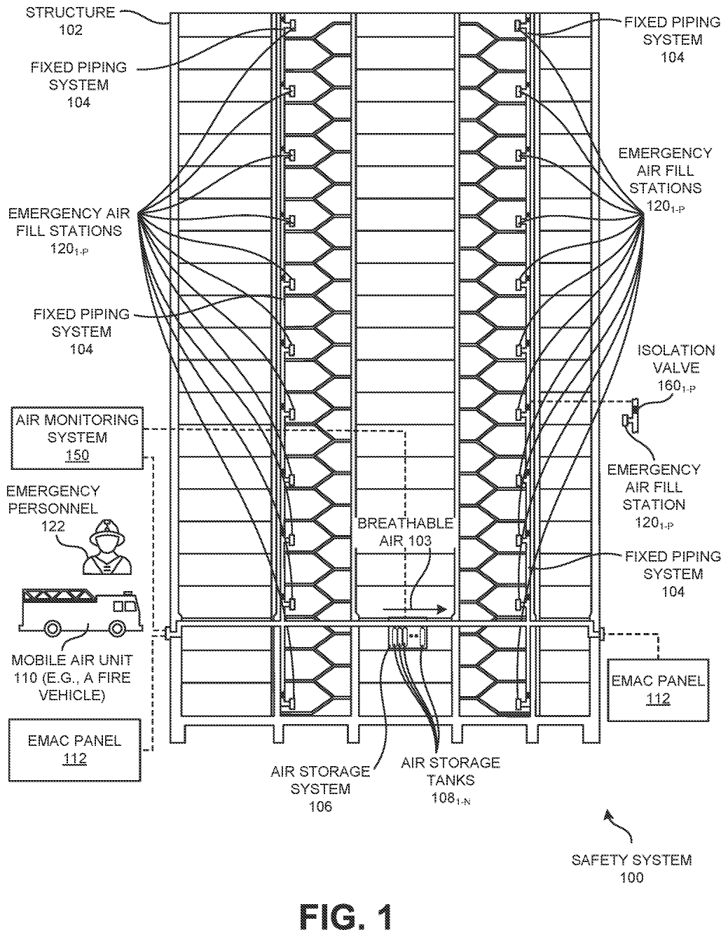

FIG. 1 shows a safety system 100 associated with a structure 102, according to one or more embodiments. In one or more embodiments, safety system 100 may be a Firefighter Air Replenishment System (FARS) to enable firefighters entering structure 102 in times of fire-related emergencies to gain access to breathable (e.g., human breathable) air (e.g., breathable air 103) in-house without the need of bringing in air bottles/cylinders to be transported up several flights of stairs of structure 102 or deep thereinto, or to refill depleted air bottles/cylinders that are brought into structure 102. In one or more embodiments, safety system 100 may supply breathable air provided from a supply of air tanks (to be discussed) stored in structure 102. When a fire department vehicle arrives at structure 102 during an emergency, breathable air supply typically may be provided through a source of air connected to said vehicle. In one or more embodiments, safety system 100 may enable firefighters to refill air bottles/cylinders thereof at emergency air fill stations (to be discussed) located throughout structure 102. Specifically, in some embodiments, firefighters may be able to fill air bottles/cylinders thereof at emergency air fill stations within structure 102 under full respiration in less than one to two minutes.

In one or more embodiments, structure 102 may encompass vertical building structures, horizontal building structures (e.g., shopping malls, hypermarts, extended shopping, storage and/or warehousing related structures), tunnels, marine craft (e.g., large marine vessels such as cruise ships, cargo ships, submarines and large naval craft, which may be “floating” versions of buildings and horizontal structures) and mines. Other structures are within the scope of the exemplary embodiments discussed herein. In one or more embodiments, safety system 100 may include a fixed piping system 104 permanently installed within structure 102 serving as a constant source of replenishment of breathable air 103. Fixed piping system 104 may be regarded as being analogous to a water piping system within structure 102 or another structure analogous thereto for the sake of imaginative convenience.

As shown in FIG. 1, fixed piping system 104 may distribute breathable air 103 across floors/levels of structure 102. For the aforementioned purpose, fixed piping system 104 may distribute breathable air 103 from an air storage system 106 (e.g., within structure 102) including a number of air storage tanks 108_{1-N} that serve as sources of pressurized/compressed air (e.g., breathable air 103). Additionally, in one or more embodiments, fixed piping system 104 may interconnect with a mobile air unit 110 (e.g., a fire vehicle) through an External Mobile Air Connection (EMAC) panel 112.

In one or more embodiments, EMAC panel 112 may be a boxed structure (e.g., exterior to structure 102) to enable the interconnection between mobile air unit 110 and safety system 100. For example, mobile air unit 110 may include an on-board air compressor to store and replenish pressurized/compressed air (e.g., breathable air analogous to breathable air 103) in air bottles/cylinders (e.g., utilizable with Self-Contained Breathing Apparatuses (SCBAs) carried by firefighters). Mobile air unit 110 may also include other pieces of air supply/distribution equipment (e.g., piping and/or air cylinders/bottles) that may be able to leverage the sources of breathable air 103 within safety system 100 through EMAC panel 112. Firefighters, for example, may be able to fill breathable air (e.g., breathable air 103, breathable air analogous to breathable air 103) into air bottles/cylinders (e.g., spare bottles, bottles requiring replenishment of breathable air) carried on mobile air unit 110 through safety system 100.

In FIG. 1, EMAC panel 112 is shown at two locations merely for the sake of illustrative convenience. In one or more embodiments, an air monitoring system 150 may be installed as part of safety system 100 to automatically track and monitor a parameter (e.g., pressure) and/or a quality (e.g., indicated by moisture levels, carbon monoxide levels) of breathable air 103 within safety system 100. FIG. 1 shows air monitoring system 150 as communicatively coupled to air storage system 106 and EMAC panel 112 merely for the sake of example. It should be noted that EMAC panel 112 may be at a remote location associated with (e.g., internal to, external to) structure 102. In one or more embodiments, for monitoring the parameters and/or the quality of breathable air within safety system 100, air monitoring system 150 include appropriate sensors and circuitries therein. For example, a pressure sensor (to be discussed) within air monitoring system 150 may automatically sense and record a pressure of breathable air 103 of safety system 100. Said pressure sensor may communicate with an alarm system that is triggered when the sensed pressure is outside a safety range. Also, in one or more embodiments, air monitoring system 150 may automatically trigger a shutdown of breathable air distribution through safety system 100 in case of impurity/contaminant (e.g., carbon monoxide) detection therethrough yielding levels above a safety/predetermined threshold.

In one or more embodiments, fixed piping system 104 may include pipes (e.g., constituted out of stainless steel tubing) that distribute breathable air 103 to a number of emergency air fill stations 120_{1-P} within structure 102. In one example implementation, each emergency air fill station 120_{1-P} may be located at a specific level of structure 102. If structure 102 is regarded as a vertical building structure, an emergency air fill station 120_{1-P} may be located at each of a basement level, a first floor level, a second floor level and so on. For example, emergency air fill station 120_{1-P} may be located at the end of the flight of stairs that emergency fighting personnel (e.g., firefighting personnel) need to climb to reach a specific floor level within the vertical building structure.

In one or more embodiments, an emergency air fill station 120_{1-P} may be a static location within a level of structure 102 that provides emergency personnel 122 (e.g., firefighters, emergency responders) with the ability to rapidly fill air bottles/cylinders (e.g., SCBA cylinders) with breathable air 103. In one or more embodiments, emergency air fill station 120_{1-P} may be an emergency air fill panel or a rupture containment air fill station. In one or more embodiments, proximate each emergency air fill station 120_{1-P}, safety system 100 may include an isolation valve 160_{1-P} to isolate a corresponding emergency air fill station 120_{1-P} from a rest of safety system 100. For example, said isolation may be achieved through the manual turning of isolation valve 160_{1-P} proximate the corresponding emergency air fill station 120_{1-P} or remotely (e.g., based on automatic turning) from air monitoring system 150. In one example implementation, air monitoring system 150 may maintain breathable air supply to a subset of emergency air fill stations 120_{1-P} via fixed piping system 104 through control of a corresponding subset of isolation valves 160_{1-P} and may isolate the other emergency air fill stations 120_{1-P} from the breathable air supply. It should be noted that configurations and components of safety system 100 may vary from the example safety system 100 of FIG. 1.

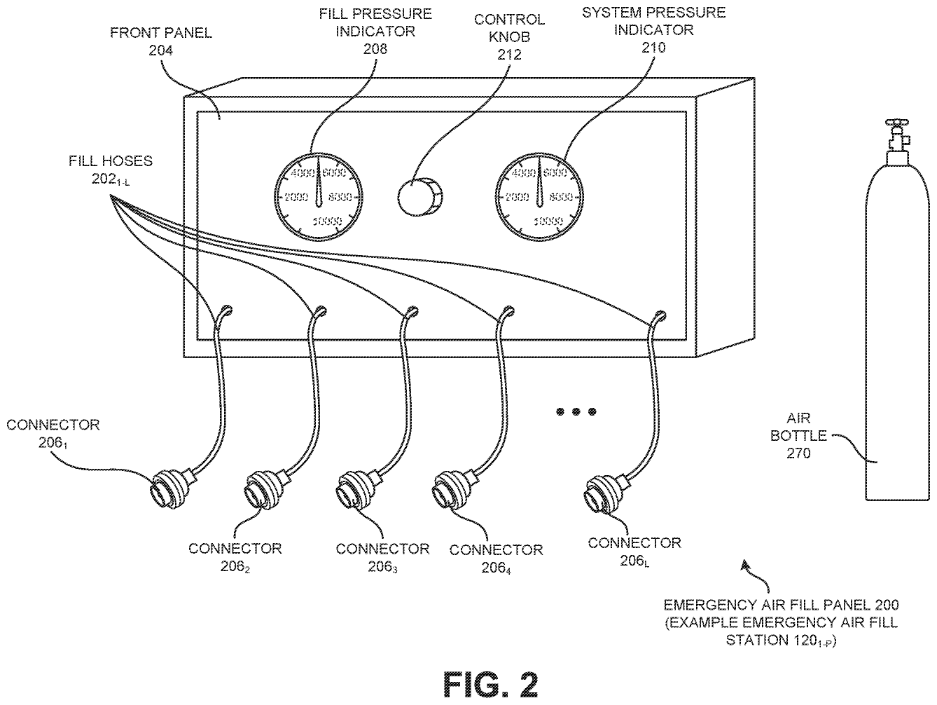

FIG. 2 shows an emergency air fill panel 200 as an example emergency air fill station 120_{1-P}, according to one or more embodiments. In one or more embodiments, emergency air fill panel 200 may enable emergency personnel 122 (e.g., firefighters, emergency responders, maintenance personnel) to rapidly fill air bottles/cylinders thereof through the use of connectors. In one or more embodiments, a number of fill hoses 202_{1-L} may protrude from a front panel 204 of emergency air fill panel 200; each of said fill hoses 202_{1-L} may have a connector 206_{1-L} (e.g., a Rapid Intervention Crew Universal Air Coupling (RIC/UAC) connector) at an end (e.g., free end) thereof not attached to front panel 204. In one or more embodiments, emergency air fill panel 200 may be directly coupled (e.g., connected) to air bottles/cylinders by way of connectors 206_{1-L}. In one or more embodiments, emergency air fill panel 200 may also include a fill pressure indicator 208 (e.g., a pressure gauge) to indicate a pressure (e.g., a standard pressure) to which an air bottle/cylinder may be filled, a system pressure indicator 210 to indicate a current pressure level of breathable air 103 in safety system 100, and a control knob 212 to adjust the pressure to which the air bottle/cylinder may be filled such that said pressure does not exist a safety threshold thereof (e.g., the safety threshold that safety system 100 may be designed for).

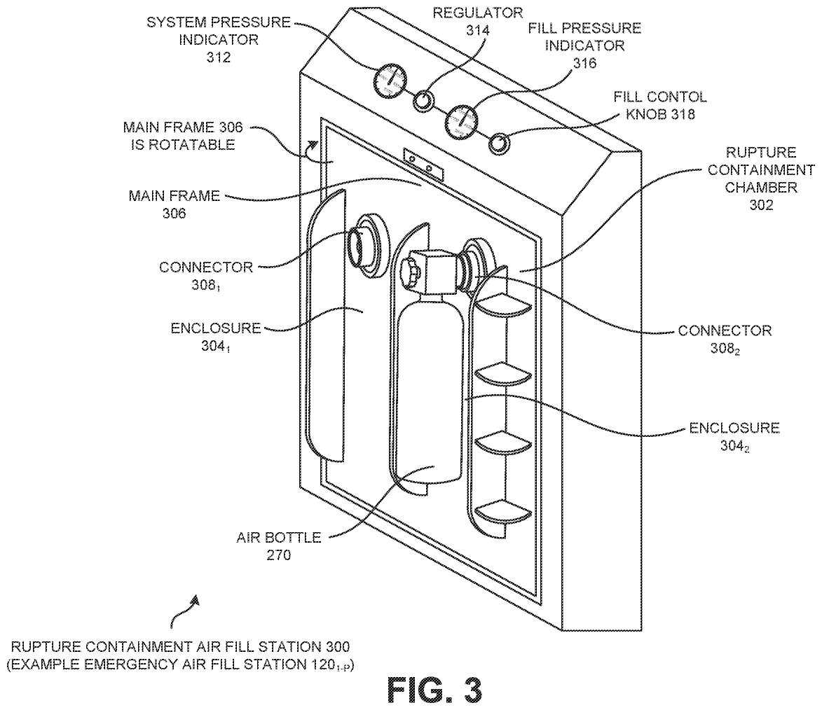

In one or more embodiments, connecting emergency air fill panel 200 to air bottles/cylinders through fill hoses 202_{1-L} thereof may enable precious time to be saved on behalf of emergency personnel 122 (e.g., firefighters, maintenance personnel, emergency responders) who, without capabilities therefor, need to remove emergency equipment from rescue attires thereof before being supplied with breathable air 103. FIG. 3 shows a rupture containment air fill station 300 as another example emergency air fill station 120_{1-P}, according to one or more embodiments. In one or more embodiments, rupture containment air fill station 300 may constitute a rupture containment chamber that facilitates shielding of over-Pressurized air cylinders/bottles and containment thereof within the rupture containment chamber to prevent injuries due to bursts/ruptures thereof. As seen in FIG. 3, in one or more embodiments, rupture containment air fill station 300 may include a rupture containment chamber 302 with specific enclosures 304₁₋₂ for accommodating air cylinders/bottles therewithin. In one or more embodiments, each enclosure 304₁₋₂ may provide space to accommodate an air cylinder/bottle therewith by way of the air cylinder/bottle being connected to rupture containment air fill station 300.

In one or more embodiments, rupture containment chamber 302 may have a main frame 306 thereof that includes a connector 308₁₋₂ (e.g., analogous to connectors 206_{1-L}) provided within or proximate each enclosure 304₁₋₂. As shown in FIGS. 2-3, a connector 206_{1-L}/connector 308₁₋₂ may be utilized to couple an air bottle 270 to emergency air fill panel 200/rupture containment air fill station 300 to enable filling (or replenishment) thereof with breathable air 103. In one or more embodiments, main frame 306 may be rotatable such that, upon rotation, main frame 306 with air bottle 270 within an enclosure 304₁₋₂ may be isolated from an external environment of rupture containment air fill station 300. In one or more embodiments, in this state of isolation, air bottle 270 may not be visible or not face emergency personnel 122 in front of rupture containment air fill station 300.

In one or more embodiments, as seen in FIG. 3, rupture containment air fill station 300 may include a system pressure indicator 312 (e.g., analogous to system pressure indicator 210) indicating the pressure level at which breathable air 103 is being delivered through safety system 100, a regulator 314 to adjust the pressure of the source (e.g., air storage system 106) of the compressed breathable air (e.g., breathable air 103) to ensure that said pressure may not exceed a design pressure of safety system 100, a fill pressure indicator 316 (e.g., analogous to fill pressure indicator 208) to indicate a pressure (e.g., a standard pressure) to which air bottle 270 may be filled, and a fill control knob 318 (e.g., analogous to control knob 212) to control the pressure to which air bottle 270 may be filled such that said pressure does not exceed a safety threshold thereof within safety system 100.

It should be noted that FIG. 3 merely shows two enclosures 304₁₋₂ and two connectors 308₁₋₂ for the sake of illustrative convenience and that any number of enclosures and connectors are within the scope of the exemplary embodiments discussed herein. The same thing may also apply to FIG. 2 and the number of fill hoses 202_{1-L} and connectors 206_{1-L} in emergency air fill panel 200. Also, it should be noted that the components of emergency air fill panel 200 and rupture containment air fill station 300, and layouts, distribution and the numbers thereof may vary. FIGS. 2 and 3 merely illustrate an example emergency air fill panel 200 and a rupture containment air fill station 300 respectively. It should further be noted that all kinds of emergency air fill stations 120_{1-P} are within the scope of the exemplary embodiments discussed herein.

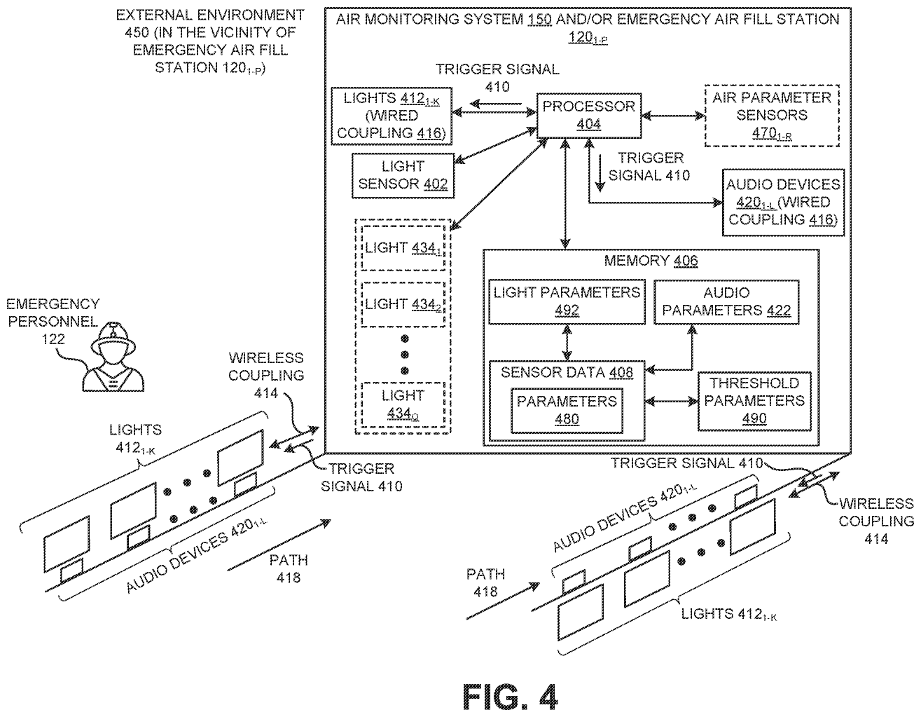

During a condition of low visibility in an environment of one or more emergency air fill station(s) 120_{1-P}, movement of emergency personnel 122 may be impaired (e.g., because of the low visibility). Exemplary embodiments provide for detection of said low visibility and facilitating movement of emergency personnel 122 toward the one or more emergency air fill station(s) 120_{1-P}. For the aforementioned purpose, in one or more embodiments, a path within structure 102 toward the one or more emergency air fill station(s) 120_{1-P} may be appropriately illuminated and/or the one or more emergency air fill station(s) 120_{1-P} may have illumination associated therewith, as will be discussed below. FIG. 4 shows air monitoring system 150 and/or emergency air fill station 120_{1-P} (e.g., emergency air fill panel 200, rupture containment air fill station 300) including a light sensor 402 configured to sense visibility of an environment (e.g., external environment 450) in a vicinity of emergency air fill station 120_{1-P}, according to one or more embodiments. In one or more embodiments, light sensor 402 may also be configured to sense visibility of emergency air fill station 120_{1-P} (e.g., by sensing states of light components/devices of emergency air fill station 120_{1-P} such as one or more lights 434_{1-Q} thereon) itself.

Light sensor 402, as discussed herein, may encompass all mechanisms (e.g., internal photoelectric effect based) of sensing visibility of external environment 450 and/or lights 434_{1-Q}. FIG. 4 shows emergency air fill station 120_{1-P} and/or air monitoring system 150 with a processor 404 (e.g., a microcontroller, a processor) communicatively coupled to a memory 406 (e.g., a volatile and/or a non-volatile memory), according to one or more embodiments. In one or more embodiments, light sensor 402 may be interfaced with processor 404. Sensor data 408 associated with the sensing of visibility of external environment 450 and/or lights 434_{1-Q} may be stored in memory 406, according to one or more embodiments. FIG. 4 shows lights 434_{1-Q} in dotted lines to indicate that lights 434_{1-Q} are solely part of emergency air fill station 120_{1-P} and not part of air monitoring system 150.

Additionally, in one or more embodiments, air monitoring system 150 may include one or more air parameter sensors 470_{1-R} configured to sense parameters 480 (it should be noted that visibility parameters sensed by light sensor 402 may also be part of parameters 480) associated with breathable air 103 such as pressure, temperature, oxygen content, carbon monoxide content, hydrocarbon content and moisture content; other parameters are within the scope of the exemplary embodiments discussed herein. FIG. 4 shows air parameter sensors 470_{1-R} in dotted lines to indicate that air parameter sensors 470_{1-R} are solely part of air monitoring system 150 and not part of emergency air fill station 120_{1-P}. In one or more embodiments, data sensed by the aforementioned air parameter sensors 470_{1-R} may also be part of sensor data 408.

It should be noted that a visibility parameter (e.g., part of parameters 480), as discussed herein, may include any parameter of external environment 450 and/or lights 434_{1-Q} that affects the visibility of emergency air fill station 120_{1-P} with respect to an occupant (e.g., emergency personnel 122) of an area within structure 102 associated therewith. Example visibility parameters may include but are not limited to lighting levels, lighting states discussed above, smoke levels (need not be limited to detection through light sensor 402) and sensor-detected (e.g., light sensor 402 such as a camera device) visibility parameters in general.

In one or more embodiments, in response to light sensor 402 detecting low visibility of external environment 450 and/or lights 434_{1-Q} (e.g., by way of lights 434_{1-Q} not working, lights 434_{1-Q} emitting a dim light, external environment 450 having poor or no lighting (e.g., a power cut due to an emergency)), processor 404 may automatically transmit a trigger signal 410 to trigger the turning (or, switching) on of one or more lights 412_{1-K} (e.g., output light devices such as Light Emitting Diode (LED) devices) in external environment 450 and/or emergency air fill station 120_{1-P} (e.g., on a door thereof) to enable emergency personnel 122 to be guided to (or, in general, to locate) emergency air fill station 120_{1-P}. In one or more embodiments, lights 412_{1-K} may be coupled wirelessly (e.g., wireless coupling 414 shown in FIG. 4) to air monitoring system 150 and/or emergency air fill station 120_{1-P} or through wired means (e.g., wired coupling 416 shown in FIG. 4).

In one or more embodiments, as shown in FIG. 4, one or more lights 412_{1-K} may be arranged along a path 418 within structure 102 toward emergency air fill station 120_{1-P} and/or arranged on emergency air fill station 120_{1-P} (e.g., on a door of emergency air fill panel 200) or in proximity thereto to enable emergency personnel 122 access breathable air 103 during low visibility conditions. In one or more embodiments, threshold parameters 490 (e.g., including thresholds for visibility: low visibility may be indicated by detection of a visibility parameter as being below a threshold; smoke-based low visibility may be indicated by detection of a light-based visibility parameter and/or a smoke-based visibility parameter as being below another threshold and so on) associated with the sensed parameters 480 including visibility may also be stored in memory 406.

In addition, to the one or more lights 412_{1-K} being turned on as a result of sensing low visibility through light sensor 402, lights 412_{1-K} also be turned on in accordance with air parameter sensors 470_{1-R}/processor 404 sensing one or more parameters 480 outside (or below) threshold parameters 490 (i.e., thresholds for comparing data sensed through air parameter sensors 470_{1-R} may also be part of threshold parameters 490) thereof. In one or more embodiments, here, parameters (e.g., light parameters 492) of lights 412_{1-K} may be automatically controlled to distinguish low visibility from other anomalies (e.g., low air quality parameter, low pressure of breathable air 103) sensed through air parameter sensors 470_{1-R}/processor 404. For example, detection of low visibility by light sensor 402/processor 404 may automatically cause one or more white lights (e.g., lights 412_{1-K}), blue lights (e.g., lights 412_{1-K}) and/or strobe lights (e.g., lights 412_{1-K}) to turn on. In the case of additionally detecting other anomalies, in one implementation, the color of the one or more lights 412_{1-K} turned on and/or blink rate thereof may automatically change. Additionally or alternatively, the number of the one or more lights 412_{1-K} turned on itself may be automatically changed through processor 404 in accordance with the detection of the other anomalies.

The number of lights 412_{1-K}, the specificities of the lights 412_{1-K}, the color of the lights 412_{1-K}, a glow intensity of the lights 412_{1-K} and so on may be regarded as light parameters 492 to be automatically controlled through processor 404 in response to the sensing discussed above. In addition, in one or more embodiments, audio devices 420_{1-L} (e.g., transducers, speakers and other audio rendering devices) may be coupled wirelessly (e.g., wireless coupling 414 shown in FIG. 4) to air monitoring system 150 and/or emergency air fill station 120_{1-P} or through wired means (e.g., wired coupling 416 shown in FIG. 4). In one or more embodiments, instead of or in addition to the control of lights 412_{1-K} and/or light parameters 492, processor 404 may control audio devices 420_{1-L} and/or audio parameters 422 (e.g., types of pre-recorded audio sounds, messages, audio intensities and/or period between audio sounds) stored in memory 406 along with light parameters 492 in response to detection of low visibility through light sensor 402 and/or the anomalies through air parameter sensors 470_{1-R} to enable location of emergency air fill station 120_{1-P}. For example, a pre-recorded audio message such as “The emergency air fill station is located here” may serve as an indicator of the location of emergency air fill station 120_{1-P} to emergency personnel 122 during low visibility conditions. Another pre-recorded message such as “The pressure of the breathable air is low!” may serve as an indicator of a status of breathable air 103 to be accessed at emergency air fill station 120_{1-P} by emergency personnel 122.

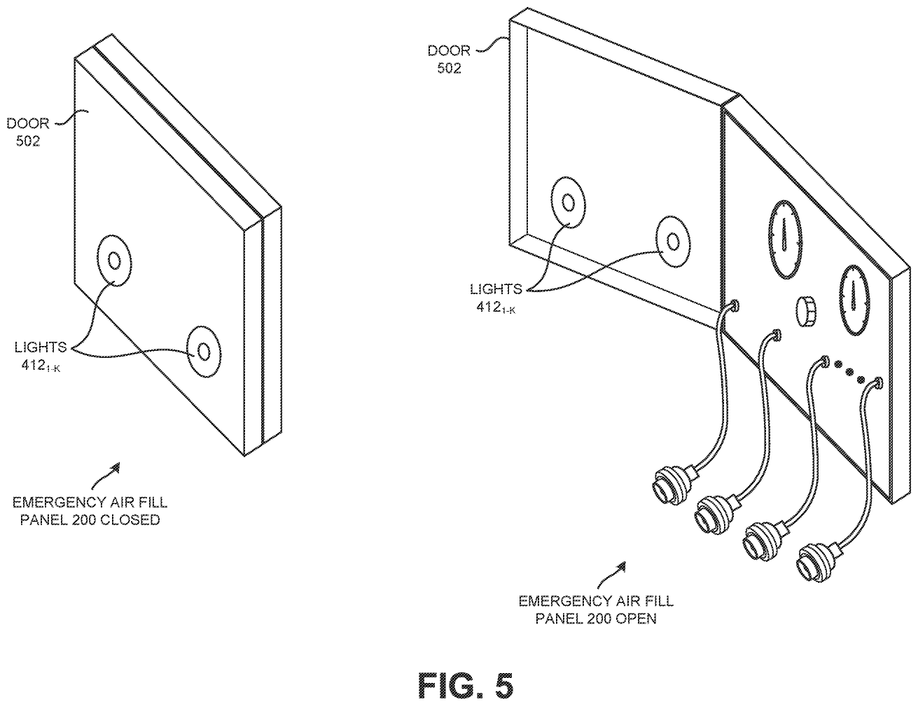

All reasonable variations are within the scope of the exemplary embodiments discussed herein. FIG. 5 shows emergency air fill panel 200 of FIG. 2 with one or more lights 412_{1-K} that are automatically turned on in accordance with the detection of the low visibility by light sensor 402. As shown in FIG. 5, the one or more lights 412_{1-K} may be provided on an inner surface or an outer surface of a door 502 of emergency air fill panel 200 (or, to generalize, emergency air fill station 120_{1-P}; even rupture containment air fill station 300 is encompassed thereby). Other locations of the lights 412_{1-K} on emergency air fill panel 200/emergency air fill station 120_{1-P} are within the scope of the exemplary embodiments discussed herein.

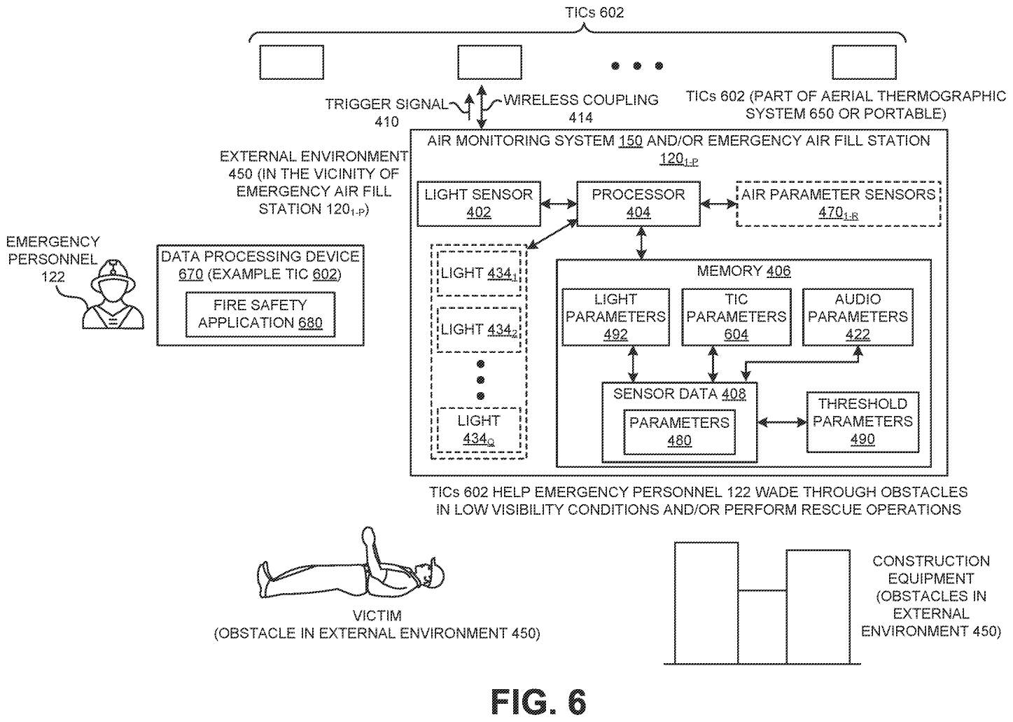

It should be noted elements of FIGS. 4 and 5 that are irrelevant to the concepts discussed in conjunction therewith have been dispensed with therein merely for the sake of clarity and convenience. FIG. 6 shows one or more thermal imaging cameras (TICs) 602 communicatively coupled (e.g., through wireless coupling 414, wired coupling 416 may also be possible) to air monitoring system 150 and/or emergency air fill station 120_{1-P}, according to one or more embodiments. It should be noted that FIG. 6 does not show lights 412_{1-K} or audio devices 420_{1-L} merely for the sake of convenience and clarity and that the concepts associated with TICs 602 may also be applicable to the discussion associated with FIGS. 4-5. In one or more embodiments, TICs 602 may be infrared cameras that sense infrared energy of objects to render images/video frames thereof corresponding to surface temperatures of said objects. In one or more embodiments, TICs 602 may be portable devices (e.g., distinct devices, data processing devices 670 associated with emergency personnel 122, each of which executes a fire safety application 680 therein; said each data processing device 670 may even be communicatively coupled to a remote server configured to control processor 404) configured to be held by emergency personnel 122 and/or part of an aerial thermographic system implemented in safety system 100 in the vicinity of one or more emergency air fill station 120_{1-P}.

In one or more embodiments, the aerial thermographic system (e.g., aerial thermographic system 650 shown in FIG. 6) may enable thermal imaging of external environment 450 to help emergency personnel 122 wade through obstacles (e.g., construction equipment, victims of emergencies at structure 102), locate emergency air fill station 120_{1-P} and/or the obstacles and/or perform rescue/maintenance operations within structure 102. Thus, the control of light parameters 492/audio parameters 422 may be analogous to the control of TIC parameters 604 shown in memory 406 in FIG. 6). For example, detection of low visibility through light sensor 402 may result in one or more TICs 602 being activated (e.g., through trigger signal 410) by processor 404 to enable emergency personnel 122 locate emergency air fill station 120_{1-P}, construction equipment, components of safety system 100 and/or victims of emergencies and/or perform rescue/maintenance operations. To generalize, in one or more embodiments, TICs 602 may aid decision making on the part of emergency personnel 122.

It should be noted that that TICs 602 may not be the only imaging devices capable of being used and that any imaging device that provides images to allow emergency personnel 122 to locate obstacles, objects and/or emergency air fill station 120_{1-P} in low visibility or no-light conditions is within the scope of the exemplary embodiments discussed herein.

It should be noted that all operations discussed above have been shown to be performed by processor 404 incorporated into air monitoring system 150 and/or emergency air fill station 120_{1-P}. However, it should be noted that processor 404 and/or memory 406 may be implemented in any component external to emergency air fill station 120_{1-P}. All reasonable variations are within the exemplary embodiments discussed herein.

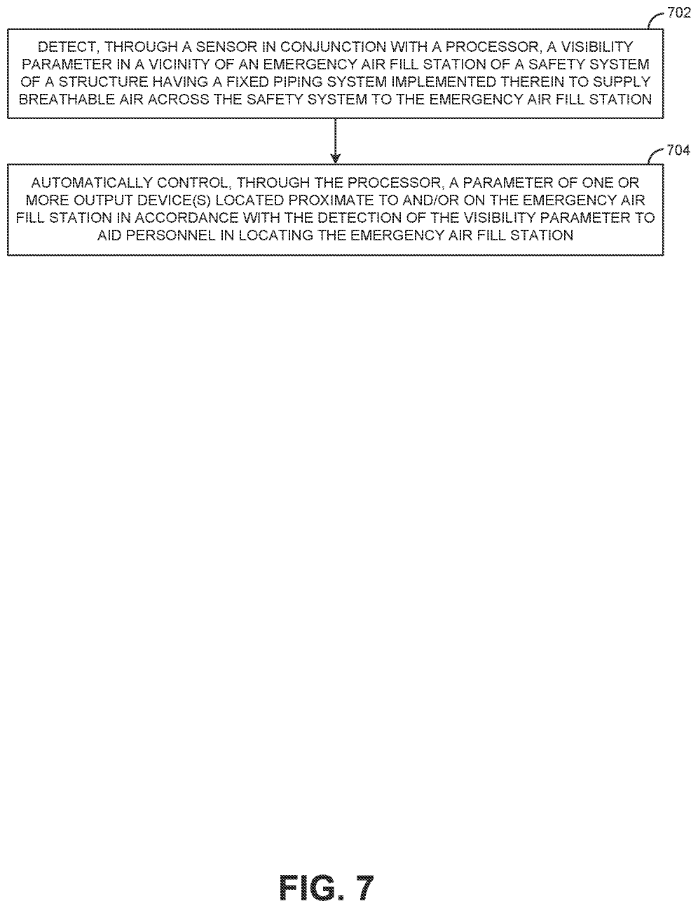

FIG. 7 shows a process flow diagram detailing the operations involved in locating an emergency air fill station (e.g., emergency air fill station 120_{1-P}) of a safety system (e.g., safety system 100) implemented within a structure (e.g., structure 102) for access of breathable air (e.g., breathable air 103) in low visibility, according to one or more embodiments. In one or more embodiments, the emergency air fill station may be supplied with the breathable air through a fixed piping system (e.g., fixed piping system 104) implemented within the safety system. In one or more embodiments, the fixed piping system may distribute the breathable air across the safety system.

In one or more embodiments, operation 702 may involve detecting, through a sensor (e.g., light sensor 402) in conjunction with a processor (e.g., processor 404), a visibility parameter (e.g., part of parameters 480) in a vicinity (e.g., external environment 450, one or more of lights 434_{1-Q}) of the emergency air fill station. In one or more embodiments, operation 704 may then involve automatically controlling, through the processor, a parameter (e.g., light parameters 492, audio parameters 422, TIC parameters 604) of one or more output device(s) (e.g., lights 412_{1-K}, audio devices 420_{1-L}, TICs 602) located proximate to and/or on the emergency air fill station in accordance with the detection of the visibility parameter to aid the personnel in locating the emergency air fill station.

Last but not the least, it should be noted that the one or more output device(s) whose parameter is controlled may not be limited to lights 412_{1-K}, audio devices 420_{1-L}, TICs 602 and any imaging device in general discussed above. In some implementations, the one or more output device(s) may even be a heater attached to or associated with emergency air fill station 120_{1-P} that provides a heat signature identifiable by a TIC 602. Here, the heater may, in some scenarios, be battery operated in the event of loss of power. All reasonable variations are within the scope of the exemplary embodiments discussed herein.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method of a safety system of a structure having a fixed piping system implemented therein to supply breathable air from a source across the safety system to an emergency air fill station thereof for use by personnel to fill an air bottle, comprising:
detecting, through a sensor in conjunction with a processor, a visibility parameter in a vicinity of the emergency air fill station; and
automatically controlling, through the processor, a parameter of at least one output device at least one of: located proximate to and on the emergency air fill station in accordance with the detection of the visibility parameter to aid the personnel in locating the emergency air fill station.

2. The method of claim 1, comprising automatically controlling, through the processor, the parameter of the at least one output device in response to detecting, in conjunction with the sensor, at least one of:
that the visibility parameter in an environment in the vicinity of the emergency air fill station is below a first threshold, and
that the visibility parameter of a light of the emergency air fill station is below the first threshold.

3. The method of claim 1, comprising providing, as the at least one output device, at least one of:
an output light device, an audio device, an imaging device and a heater associated with the emergency air fill station.

4. The method of claim 3, comprising at least one of:
providing a Thermal Imaging Camera (TIC) as the imaging device;
the heater providing a heat signature identifiable through the TIC; and
providing the output light device on a door of the emergency air fill station.

5. The method of claim 1, further comprising:
detecting, through another sensor in conjunction with the processor, that an air parameter of the breathable air is outside a second threshold; and
automatically triggering, through the processor, the at least one output device to signal at least one of: audibly and visibly a state corresponding to the detection that the air parameter of the breathable air is outside the second threshold.

6. The method of claim 4, comprising utilizing, through the processor, the TIC to locate at least one of: the emergency air fill station and an obstacle in the vicinity of the emergency air fill station.

7. The method of claim 1, comprising the at least one output device being at least one of: wirelessly communicatively coupled to the processor and coupled thereto in a wired manner.

8. A method of a safety system of a structure having a fixed piping system implemented therein to supply breathable air from a source across the safety system to an emergency air fill station thereof for use by personnel to fill an air bottle, comprising:
detecting, through a sensor in conjunction with a processor, that a visibility parameter in a vicinity of the emergency air fill station is below a first threshold; and
automatically controlling, through the processor, a parameter of at least one output device at least one of: located proximate to and on the emergency air fill station in accordance with the detection that the visibility parameter is below the first threshold to aid the personnel in locating the emergency air fill station.

9. The method of claim 8, comprising automatically controlling, through the processor, the parameter of the at least one output device in response to detecting, in conjunction with the sensor, at least one of:
that the visibility parameter in an environment in the vicinity of the emergency air fill station is below the first threshold, and
that the visibility parameter of a light of the emergency air fill station is below the first threshold.

10. The method of claim 8, comprising providing, as the at least one output device, at least one of:
an output light device, an audio device, an imaging device and a heater associated with the emergency air fill station.

11. The method of claim 10, comprising at least one of:
providing a TIC as the imaging device;
the heater providing a heat signature identifiable through the TIC; and
providing the output light device on a door of the emergency air fill station.

12. The method of claim 8, further comprising:
detecting, through another sensor in conjunction with the processor, that an air parameter of the breathable air is outside a second threshold; and
automatically triggering, through the processor, the at least one output device to signal at least one of: audibly and visibly a state corresponding to the detection that the air parameter of the breathable air is outside the second threshold.

13. The method of claim 11, comprising utilizing, through the processor, the TIC to additionally locate an obstacle in the vicinity of the emergency air fill station.

14. A safety system of a structure, comprising:
a source of breathable air;
a fixed piping system within the structure for supply of the breathable air from the source across the safety system;
an emergency air fill station coupled to the fixed piping system to provide access to the breathable air therethrough for personnel to fill an air bottle;
a sensor; and
a processor communicatively coupled to a memory,
wherein the sensor in conjunction with the processor detects a visibility parameter in a vicinity of the emergency air fill station, and
wherein the processor automatically controls a parameter of at least one output device at least one of: located proximate to and on the emergency air fill station in accordance with the detection of the visibility parameter to aid the personnel in locating the emergency air fill station.

15. The safety system of claim 14, wherein the processor automatically controls the parameter of the at least one output device in response to detecting, in conjunction with the sensor, at least one of:
that the visibility parameter in an environment in the vicinity of the emergency air fill station is below a first threshold, and
that the visibility parameter of a light of the emergency air fill station is below the first threshold.

16. The safety system of claim 14, wherein the at least one output device is at least one of: an output light device, an audio device, an imaging device and a heater associated with the emergency air fill station.

17. The safety system of claim 16, wherein at least one of:
the imaging device is a TIC,
the heater provides a heat signature identifiable through the TIC, and
the output light device is provided on a door of the emergency air fill station.

18. The safety system of claim 14, further comprising another sensor to, in conjunction with the processor, detect that an air parameter of the breathable air is outside a second threshold,
wherein the processor automatically triggers the at least one output device to signal at least one of: audibly and visibly a state corresponding to the detection that the air parameter of the breathable air is outside the second threshold.

19. The safety system of claim 17, wherein the processor enables utilization of the TIC to locate at least one of: the emergency air fill station and an obstacle in the vicinity of the emergency air fill station.

20. The safety system of claim 14, wherein the at least one output device is at least one of: wirelessly communicatively coupled to the processor and coupled thereto in a wired manner.
